(19) United States
(12) Patent Application Publication
(10) Pub. No.: US 2026/0253094 A1
(43) Pub. Date: Aug. 27, 2026

(54) NON-TRANSITORY COMPUTER READABLE MEDIUM FOR CHATBOT PROGRAM, CHATBOT APPARATUS, AND CHATBOT SYSTEM

(71) Applicant: Honda Motor Co., Ltd., Tokyo (JP)

(72) Inventors: Tameaki Honda, Tokyo (JP); Hiroshi Honda, Tokyo (JP); Kazuki Yoshigai, Tokyo (JP)

(21) Appl. No.: 19/538,916

(22) Filed: Feb. 12, 2026

(30) Foreign Application Priority Data
Feb. 25, 2025 (JP) 2025-027557

(51) Int. Cl. G06Q 30/02; G06Q 10/10; H04L 51/04

(52) U.S. Cl. CPC G06Q 30/02; G06Q 10/10; H04L 51/04

(57) ABSTRACT

A non-transitory computer-readable storage medium storing a chatbot program is configured to be executed by a computer. The chatbot program causes the computer to perform: a first processing including receiving, from a user terminal operated by a user, a query for an answer of a comparison result between a plurality of products or services input by the user via the user terminal from a viewpoint specified by the user, and a second processing including transmitting, to the user terminal, answer information to which information is added so that an amount of information regarding a specific product or a specific service is larger than an amount of information regarding another product or another service to be compared with the specific product or the specific service in a case where the specific product or the specific service is included in comparison targets specified in the query.

### CROSS-REFERENCE TO RELATED APPLICATION

This application is based upon and claims the benefit of priority from Japanese Patent Application No. 2025-027557 filed on February 25, 2025, the content of which is incorporated herein by reference.

### BACKGROUND

### Technical Field

The present disclosure relates to a non-transitory computer readable medium for a chatbot program, a chatbot apparatus and a chatbot system.

### Related Art

The usefulness of a large language model (LLM) is being recognized in information processing tasks with increasing complexity and diversity. Furthermore, in recent years, a system that supports sales of a product to a customer using a mobile terminal such as a smartphone or a tablet terminal has been known (see, for example, JP 2021-144416 A).

There is a system that provides a sales support service using a chatbot. In such a system, a customer connected to a chatbot inputs a question (query) for comparing performance, function, convenience, and the like between a product provided by the own company and a product of a competitor. However, those questions can be about a very limited aspect of the product. Therefore, the answer from the system may be limited, and when the customer determines the product or service to be purchased based on the answer, the customer may not be able to determine an appropriate product or service.

### SUMMARY

An aspect of the present invention is a non-transitory computer-readable storage medium storing a chatbot program configured to be executed by a computer. The chatbot program causes the computer to perform: a first processing including receiving, from a user terminal operated by a user, a query for an answer of a comparison result between a plurality of products or services input by the user via the user terminal from a viewpoint specified by the user, and a second processing including transmitting, to the user terminal, answer information to which information is added so that an amount of information regarding a specific product or a specific service is larger than an amount of information regarding another product or another service to be compared with the specific product or the specific service in a case where the specific product or the specific service is included in comparison targets specified in the query.

Another aspect of the present invention is a chatbot apparatus including: a microprocessor; and a memory connected to the microprocessor. The microprocessor is configured to perform: receiving, from a user terminal operated by a user, a query for an answer of a comparison result between a plurality of products or services input by the user via the user terminal from a viewpoint specified by the user, and transmitting, to the user terminal, answer information to which information is added so that an amount of information regarding a specific product or a specific service is larger than an amount of information regarding another product or another service to be compared with the specific product or the specific service in a case where the specific product or the specific service is included in comparison targets specified in the query.

Still another aspect of the present invention is a chatbot system including: a user terminal operated by a user, and a server including a microprocessor, and a memory connected to the microprocessor, and configured to receive, from the user terminal, a query inputted by the user via the user terminal and transmit answer information corresponding to the query. The microprocessor is configured to perform: receiving, from the user terminal, the query for an answer of a comparison result between a plurality of products or services input by the user via the user terminal from a viewpoint specified by the user, and transmitting, to the user terminal, the answer information to which information is added so that an amount of information regarding a specific product or a specific service is larger than an amount of information regarding another product or another service to be compared with the specific product or the specific service in a case where the specific product or the specific service is included in comparison targets specified in the query.

### BRIEF DESCRIPTION OF THE DRAWINGS

The objects, features, and advantages of the present invention will become clearer from the following description of embodiments in relation to the attached drawings, in which:

FIG. 1 is a conceptual diagram for explaining a general configuration of a chatbot system;

FIG. 2 is a conceptual diagram for schematically explaining a data structure of a customer database;

FIG. 3 is a conceptual diagram illustrating an example of the data structure of user data stored in the customer database;

FIG. 4 is a block diagram illustrating functional blocks of a server and components connected to the server via a network;

FIG. 5 is a flowchart illustrating general processing steps of a chatbot response process executed by a CPU of the server that provides chatbot services to users;

FIG. 6 is a flowchart illustrating an example of prompt generation processing executed by the CPU in S506 of the flowchart illustrated in FIG. 5;

FIG. 7 is a flowchart illustrating another example of prompt generation processing executed by the CPU in S506 of the flowchart illustrated in FIG. 5;

FIG. 8 is a flowchart illustrating still another example of prompt generation processing executed by the CPU in S506 of the flowchart illustrated in FIG. 5; and

FIG. 9 is a flowchart illustrating another example of the general processing steps of the chatbot response process executed by the CPU of the server that provides chatbot services to users.

### DETAILED DESCRIPTION

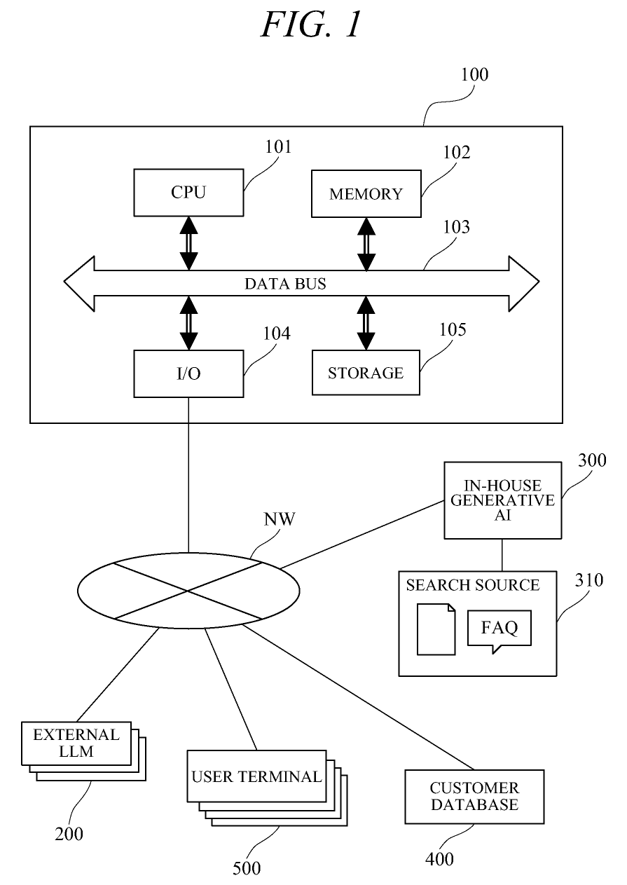

Hereinafter, an embodiment of the present disclosure will be described with reference to FIGS. 1 to 9. In all the drawings described below, common components are denoted by the same reference numerals, and repeated description is omitted. Note that not all the components shown in the following embodiments are essential components of the present disclosure.

FIG. 1 is a conceptual diagram for explaining a state in which a server 100 constituting a chatbot system is connected to an external LLM 200, a generative AI system 300, a customer database 400, and a user terminal 500 via a network NW. In the present embodiment, the chatbot system is assumed to be a system that responds to questions from the user regarding automobiles manufactured and sold by a company and services related to the automobiles.

The server 100 includes a CPU 101, a memory 102, an I/O 104, a storage 105, and a data bus 103 that enables data exchange between these elements.

A chatbot program for providing a chatbot service to the user is stored in, for example, the storage 105. The chatbot program may be read from the storage 105 when the server 100 is started, loaded into the memory 102, and executed by the CPU 101. Alternatively, the memory 102 may include a ROM, a flash memory, or the like, and a chatbot program stored in the ROM or the flash memory may be loaded into the memory 102 and executed by the CPU 101. In addition, a program obtained by being read from an optical disk drive device or a card reader (not illustrated) or being downloaded via the network NW may be loaded into the memory 102 and executed by the CPU 101.

Note that the server 100 can be virtually realized by providing all or a part of each hardware configuration in a distributed manner in a plurality of computers and connecting them to each other via the network NW. As described above, the server 100 is a concept including not only a server housed in a single housing or case but also a virtualized computer system.

The external LLM 200 is, for example, an LLM provided by a third party. The LLM (Large Language Model) is a large scale artificial intelligence model constructed by using a large set of text data and deep learning technologies, and used in the field of natural language processing (NLP). The LLM can learn a large amount of text data (web pages, books, articles, and the like) to understand patterns of languages used by humans and effectively perform natural language generation (NLG) tasks.

Hereinafter, the use of the LLM as an external source when providing a chatbot service to a user will be described as an example, but another external service utilizing AI, such as ChatGPT, Google Gemini (registered trademark), Cerence (registered trademark), or Claude3 (registered trademark), may be used. Furthermore, depending on the performance required for the chatbot, another natural language processing including a small language model (SLM) may be used.

An in-house generative AI (hereinafter, also simply referred to as a generative AI system) system 300 is a system that accumulates and constructs own information providing a chatbot service as a search source 310. The generative AI system 300 abundantly includes documents such as products and services sold and provided by the company and an operation manual accompanying the same, information, and the like regarding a frequently asked question (FAQ) in the past, and can increase accuracy of an answer generated by AI and reduce hallucination.

Furthermore, the generative AI system 300 can not only output a general answer to a question sent from the user who is driving the vehicle such as a passenger car, specifically the vehicle provided by the own company, but also make a more specific response such as “Please press the switch with a green design on the lower left among the plurality of steering switches provided on the right steering spoke”.

Furthermore, when receiving a question about a product such as a vehicle provided by the company or a service of an electronic commerce (EC) site or the like which is a website that sells a product or a service on the Internet, the generative AI system 300 can output more detailed and diverse information to the user.

In addition, since the generative AI system 300 is a system of the own company, it is advantageous in that an increase in cost can be suppressed even in a case where a transaction when interaction is performed with AI during execution of a chatbot session.

The customer database 400 is a database in which login information such as a password and user data to be described in detail later are accumulated in association with a user ID when the user logs in to the chatbot service.

The user terminal 500 is an information processing device operated by a user who uses a chatbot service provided by the server 100. For example, a smartphone, a tablet terminal, a personal digital assistant (PDA), a personal computer, or the like can be used as the user terminal 500, and an in-vehicle communication module can also be used as the user terminal 500.

The network NW for transmitting information between the elements described above can use the Internet. Note that the generative AI system 300, the customer database 400, and the server 100 may be connected via a closed network service not via the Internet, or may be connected using a virtual private network (VPN) technology. Alternatively, the generative AI system 300 and the customer database 400 may be included in the server 100. It is desirable to protect the customer database 400 using a strong encryption technology in order to enhance information security.

FIG. 2 is a conceptual diagram for schematically explaining a data structure of the customer database 400. The customer database 400 includes a user ID 402, login information 404, user data 406, and the like. The login information 404 and the user data 406 are accumulated in association with the user ID 402. The user ID 402 stores data to be referred to in collation with a user ID transmitted from the user terminal 500 at the start of a chatbot session to be described later. The login information 404 stores information such as a password corresponding to each user ID 402 and a past login date and time.

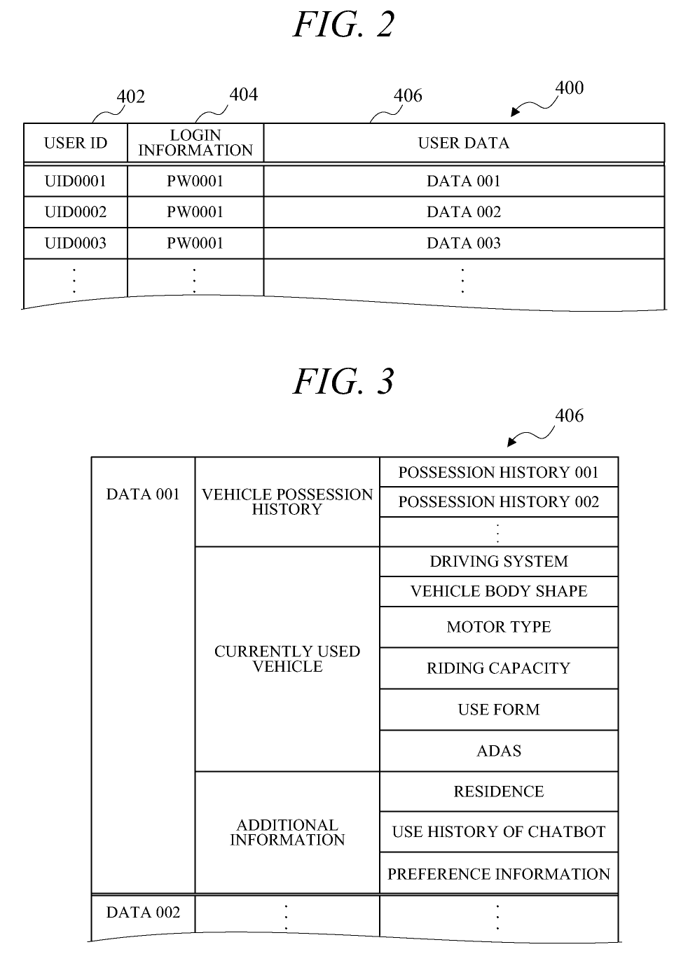

FIG. 3 is a conceptual diagram illustrating an example of information held as the user data 406. In the user data 406, information capable of specifying the amount of knowledge related to the automobile of the user, the automobile possession history of the user, the automobile use situation of the user, the automobile possession situation, the preference information of the user, and the like is stored. The user data 406 further stores information regarding a question uttered by the user in a chatbot session performed in the past and an answer thereto, session information regarding each chatbot session, and the like.

Hereinafter, an example of information recorded as the user data 406 will be described with reference to FIG. 3. The information of the automobile possession history includes information regarding an automobile type owned by the user in the past, a possession period, a specification of the owned vehicle, and the like. The information on the currently used automobile includes information on a driving system, a vehicle body shape, a motor type, a riding capacity, a use form, a function of advanced driver-assistance systems (ADAS), and the like. The additional information includes information regarding a residence of the user, a use history of the chatbot, the amount of knowledge regarding the automobile, and the like.

The driving system information can include information that can specify F/F (front engine/front-wheel drive), F/R (front engine/rear-wheel drive), M/R (midship engine/rear-wheel drive), R/R (rear engine/rear-wheel drive), AWD (all-wheel drive), and the like.

The vehicle body shape information can include information on a box shape such as a sedan, a hood shape having a hood on a cargo bed, a station wagon including a hatchback, a wagon, a one-box car, and the like. As the vehicle body shape information, it is also possible to more finely classify and store SUVs, minivans, one-box cars, deck vans, off-road vehicles, light vehicles, and the like.

The motor information can include information that can specify a gasoline engine, a diesel engine, a hydrogen engine that burns hydrogen to obtain power, a CNG engine that burns CNG (compressed natural gas) to obtain power, an HEV (hybrid vehicle using an internal combustion engine and a motor as a power source), a PHEV (plug-in hybrid vehicle), a BEV (battery electric vehicle), a FCEV (fuel cell vehicle), and the like.

The riding capacity information can include the riding capacity of the automobile currently used by the user, for example, numerical information such as 2, 4, 5, 6, 7, 8, and 10. Alternatively, information that can specify the number of front seats/rear seats that can be seated and the number of front seats/second seats/third seats that can be seated, such as 2/3, 2/2/3, and the like, can be included.

The use form information can include information that can identify what purpose and form the user often uses the automobile currently used by the user, such as short distance, commuting, leisure, and long distance drive.

The ADAS information can include information that can identify what driving support function and safety function the automobile currently used by the user has. As an example, it is possible to include information that can specify a function, such as ACC (Adaptive Cruise Control: a vehicle speed control system that automatically performs acceleration and deceleration while maintaining an inter-vehicle distance from a preceding vehicle), a LDW (Lane Departure Warning), a LKAS (Lane Keep Assist System), a RCTA (Rear Cross Traffic Alert: a system that detects a vehicle that crosses behind when the vehicle is moving backward to call driver's attention), a CMBS (Collision Mitigation Braking System), or a PPS (Pedestrian Protection System).

The information regarding the residence of the user may include information that can specify:

in apartment building, the presence/absence of a parking lot, the presence/absence of a charging facility for BEV; and

in a detached house, the presence/absence of a parking lot, the presence/absence of a charging facility for BEV, the presence/absence of V2H (Vehicle to Home: a system in which electric power stored in a battery of a BEV or a PHEV can be used at home).

The information regarding the chatbot use history can include questions, answers, and session information. The question information may include information that can specify what content of the question has been from the user when the chatbot session has been opened, including how many technical terms (vocabulary) are included by the user. The answer information may include information that can specify the breadth of the range of the vocabulary, the amount of information, and the type of information. The session information may include information that can specify user assessment and comprehension of the answer from the chatbot, a start time and an end time of the chatbot session, and the like.

The preference information is information regarding the preference of the user, and is information that can specify which vehicle the user prefers. Examples of the preference information include savings, luxury, sporty, small size, large size, and minivan.

“Savings” indicates that the user tends not to desire other equipment, size, luxuriousness, and the like as long as the user has the minimum necessary function.

“High-grade” indicates that the user tends to prefer upper-grade vehicles or equipment that is not directly related to vehicle driving performance, such as sunroofs, high-fidelity audio, seat ventilation, and massage functions.

“Sporty” indicates that the user tends to like a high-output electric motor or an internal combustion engine that is a power source of the vehicle, or to like to include a vehicle body, a drive system, a suspension system, and the like suitable for sporty traveling.

“Small”, “large”, “sedan”, “minivan”, and “hatchback” indicate the size and shape of the vehicle body preferred by the user.

“Ski”, “camping”, “fishing”, “climbing”, “cycling”, and “golf” indicate types preferred by the user as leisure using a vehicle.

“Long distance drive” indicates that the user prefers long distance drive.

The “cargo loading amount” indicates the preference of the user regarding the loading performance of the vehicle.

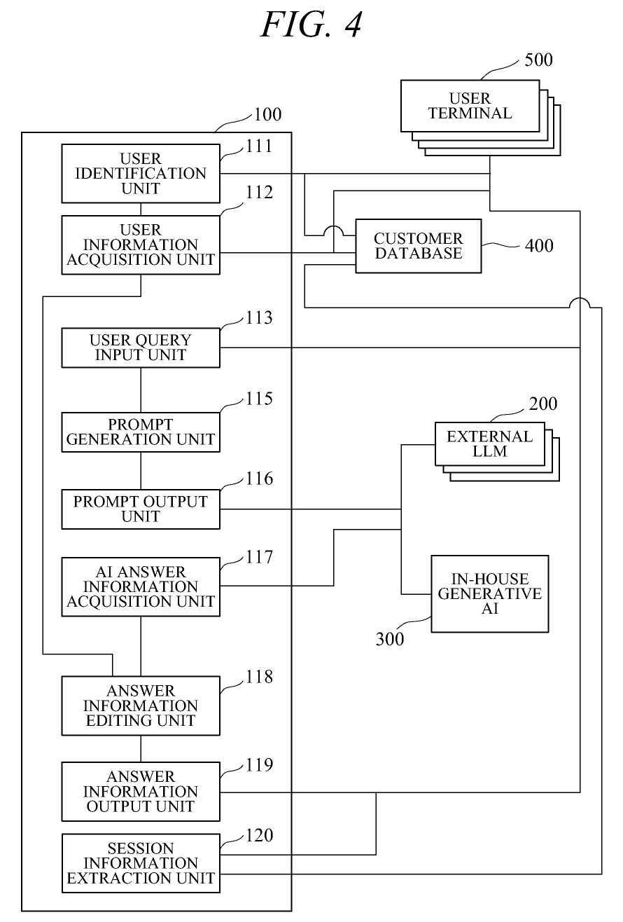

FIG. 4 is a block diagram for explaining a chatbot processing unit realized by the CPU 101 of the server 100 executing a chatbot program, and is a diagram illustrating an external element connected to the server 100 via the network NW.

A user identification unit 111 exchanges a user ID and a password with the user terminal 500 that is connected to the server 100 and intends to start a chatbot session, and identifies and authenticates the user based on the user ID 402 and the login information 404 acquired by accessing the customer database 400. A user information acquisition unit 112 acquires the user data 406 corresponding to the user identified by the user identification unit 111 from the customer database 400.

When the user data 406 is not registered in the customer database 400, the user information acquisition unit 112 outputs a chat for requesting a user (hereinafter, referred to as a chat user) who operates the user terminal 500 being logged in to input necessary information. In response to a question from the chatbot, the chat user inputs user information on which the user data 406 (FIG. 3) registered in the customer database 400 is based.

A user query input unit 113 inputs a query input from the chat user and outputs the query to a prompt generation unit 115. The query input from the chat user may be text-based or by voice input. The prompt generation unit 115 analyzes the query input from the user, and generates a prompt to be output to the external LLM 200 or the generative AI system 300. In the present embodiment, an example in which a plurality of external LLMs 200 and a generative AI system 300 are provided will be described, but only one of them may be provided as a destination to which a prompt is to be output. The prompt generation unit 115 is also configured to be able to generate a prompt based on the user data 406 acquired by the user information acquisition unit 112. Details of this prompt generation based on the user data 406 will be described later.

In a case where a plurality of candidates is provided as a destination to which the prompt is to be output, the server 100 may determine whether to output the prompt to either the external LLM 200 or the generative AI system 300 according to the query from the chat user and the user automotive information specific to the chat user, and the prompt generation unit 115 may generate an input sentence corresponding to the output destination.

A prompt output unit 116 outputs the input sentence which is generated by the prompt generation unit 115 and input to the LLM, that is, the prompt, to any output destination determined by the server 100.

An AI answer information acquisition unit 117 receives an answer from the external LLM 200 or the generative AI system 300 to which the prompt output unit 116 has output the prompt. In the present specification, the answer received by the AI answer information acquisition unit 117 from the external LLM 200 or the generative AI system 300 as a destination to which the prompt output unit 116 outputs the prompt is referred to as an original answer.

An answer information editing unit 118 performs an editing processing on the original answer acquired by the AI answer information acquisition unit 117 and generates answer information to be presented to the chat user. As the editing processing, it is possible to simply arrange the sentence, or perform the editing processing on the basis of the user data 406 unique to the chat user acquired by the user information acquisition unit 112, and generate answer information in which the type of information, the amount of information, the vocabulary, and the like are customized for each chat user.

More specifically, the editing processing is performed as follows. That is, the amount of knowledge related to the automobile of the chat user is determined based on the information regarding the amount of knowledge and the chatbot use history described with reference to FIG. 3, and it is determined at what level of detail the information is provided, what level of technical terms the information is provided (range of vocabulary), and what type of information is provided. Alternatively or in addition, with reference to the information of the automobile possession history of the user, the amount of knowledge related to the automobile of the chat user can be determined, and at what level of detail the information is provided, what level of technical terms the information is provided (range of vocabulary), and what type of information is provided can be determined.

In addition, it is also possible to perform editing processing of adding information that makes the user more interested on the basis of the preference information of the user.

In addition, it is assumed that a question from the chat user is a question “I want to know about the charging facility of the BEV”. Then, it is assumed that, as a result of referring to the user data 406 specific to the chat user, it is determined that the chat user lives in an apartment building with a parking lot and does not have a charger, based on the information regarding the residence of the chat user. The answer information editing unit 118 can perform the editing processing so as to reduce or omit the information regarding the home charging facility in the original answer and generate answer information in which at least one of the range of vocabulary, the amount of information, and the type of information is limited to the information regarding the charging facility located near the residence of the chat user.

An answer information output unit 119 outputs the answer information edited by the answer information editing unit 118 to the user terminal 500.

When one chatbot session ends, a session information extraction unit 120 extracts information that can specify a query and an answer exchanged within the chatbot session, information regarding evaluation from the chat user for an answer from the chatbot, information that can specify a degree of understanding of the chat user, and information that can specify when the chatbot session starts and ends, and adds the extracted information to the user data 406 in the customer database 400.

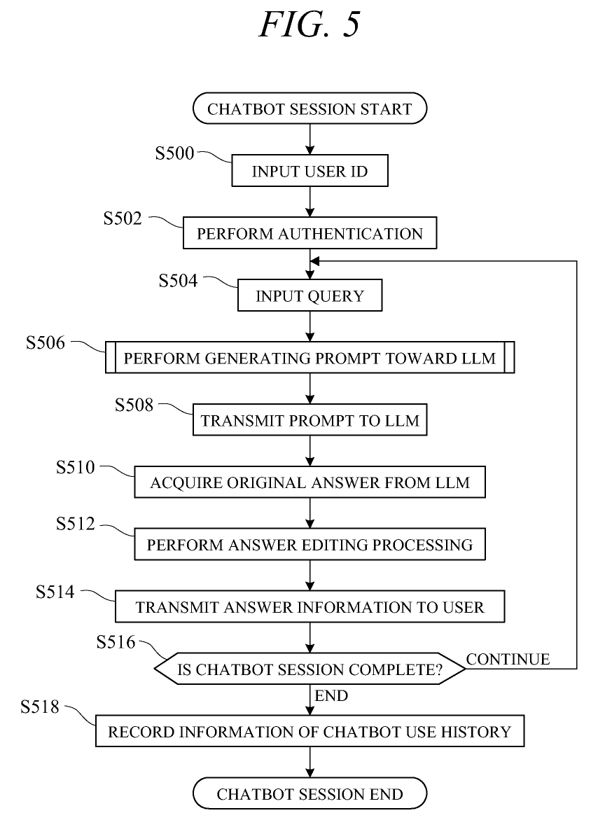

FIG. 5 is a flowchart illustrating a flow of chatbot response processing executed by the CPU 101 of the server 100. When the chat user operates the user terminal 500 to start the chatbot session, the CPU 101 acquires the user ID from the user terminal 500 in S500.

In S502, the CPU 101 accesses the customer database 400 to acquire the login information 404 and the user data 406 corresponding to the login ID of the chat user. Then, the CPU 101 performs authentication processing by collating the password information included in the login information 404 with the password input from the chat user.

In S504, the CPU 101 inputs the query uttered by the chat user. In S506, the CPU 101 analyzes the content of the query input from the chat user in S504, determines an LLM to which a prompt is to be output, and generates a prompt to output toward the LLM. If there is only one LLM connected to the server 100, the process of determining the output destination LLM can be omitted.

The LLM to which the prompt is to be output can be determined on the basis of the field of specialization for each LLM, the detail level of the answer sentence, and the like. Furthermore, in a case where the content of the query relates to the company's product, for example, in a case where the content relates to the operation method, specification, or the like of the vehicle owned by the chat user, the generative AI system 300 may be determined as the output destination of the prompt.

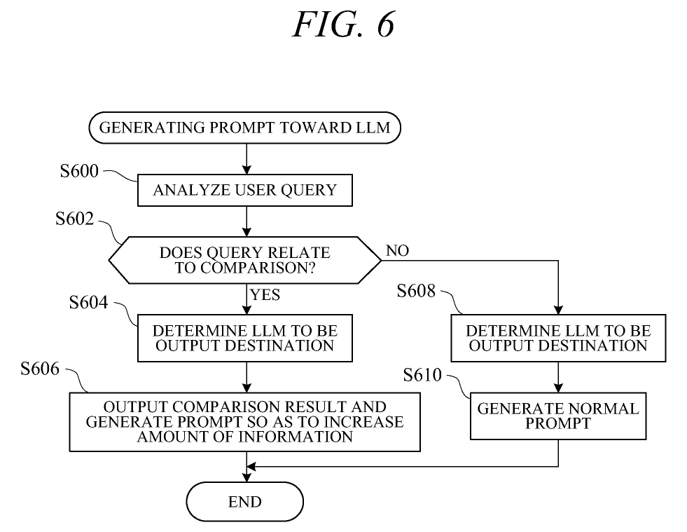

Details of the prompt generation processing for LLM (hereinafter, it may be simply referred to as prompt generation processing) performed in S506 will be described later in detail with reference to FIGS. 6 to 8.

In S508, the CPU 101 outputs a prompt to the output destination LLM determined in S506, and acquires an answer output from the LLM in association with the prompt in S510.

In S512, the CPU 101 performs the editing processing on the original answer, that is, the answer obtained in S510 based on the user data obtained in S502, and generates answer information to be transmitted to the chat user. That is, the CPU 101 executes the function of the answer information editing unit 118 described with reference to FIG. 4.

In S514, the CPU 101 transmits the answer information generated in S512 to the user terminal 500 possessed by the chat user.

When it is determined in S516 that the chatbot session continues, that is, a further query is input from the chat user, the CPU 101 returns to S504 and continues the series of processing in S504 to S516 described above. On the other hand, when it is determined in S516 that the chatbot session has been completed, the CPU 101 records information of the chatbot use history in S518. The information of the chatbot use history includes the information extracted by the session information extraction unit 120 described with reference to FIG. 4. When the processing in S518 is completed, the CPU 101 enters a standby state until a new chatbot session is started.

FIG. 6 is a flowchart illustrating prompt generation processing executed by the CPU 101 in S506 of the flowchart illustrated in FIG. 5.

In S600, the CPU 101 analyzes the user query input in S504. In S602, the CPU 101 determines whether the query sent from the chat user relates to a comparison including a specific product or a specific service and another product or another service.

Here, the specific product and the specific service are recorded (registered) in advance in the server 100 constituting the chatbot system, for example, in the storage 105. The specific products and the specific services include products and services provided to customers by a company or an organization that operates a chatbot system, are products of the company or services provided by the company, and are subject to sales promotion. In the example described with reference to FIG. 3, the user data 406 relates to a vehicle such as a private car, and according to the example, the specific product can be a vehicle or an accessory part provided by the company. In addition, the specific service may be an EC site or the like that is operated by the company and provides services to customers. On the other hand, other products and other services may be products and services provided by companies and organizations other than the own company.

When the determination in S602 is affirmative, the CPU 101 determines the LLM to be the output destination based on the user query in S604, and generates a prompt to be output to the LLM in S606. At that time, the CPU 101 outputs a result of comparing the specific product or the specific service with another product or another service, and generates a prompt to add information so as to increase the amount of information regarding the specific product or the specific service.

The process of generating a prompt in S606 will be further described. The chatbot service according to the present embodiment is intended to provide a chat user with a new user experience (UX), that is, a customer experience, and is also intended to promote the company's products and services. Therefore, in a case where a query for comparing the specific product or the specific service with another product or another service, that is, the company's product or the service provided by the own company, and the service provided by another company or another company is issued from the viewpoint specified by the chat user, the CPU 101 performs processing as follows. Specifically, the CPU 101 accurately informs the chat user of the comparison result as a fact, and generates a prompt to add more information about the company's products or the services provided by the company. In this manner, the CPU 101 generates a prompt so that the attraction of the company's product or the service provided by the company can be easily conveyed to the chat user.

On the other hand, when the determination in S602 is negative, the CPU 101 determines the output destination LLM based on the user query in S608, and generates a normal prompt to output to the LLM in step S610. Here, the normal prompt means a prompt that does not include an instruction to increase the amount of information on the specific product or the specific service.

The above embodiments can be modified in various manners. Hereinafter, modifications will be described.

### First Modification

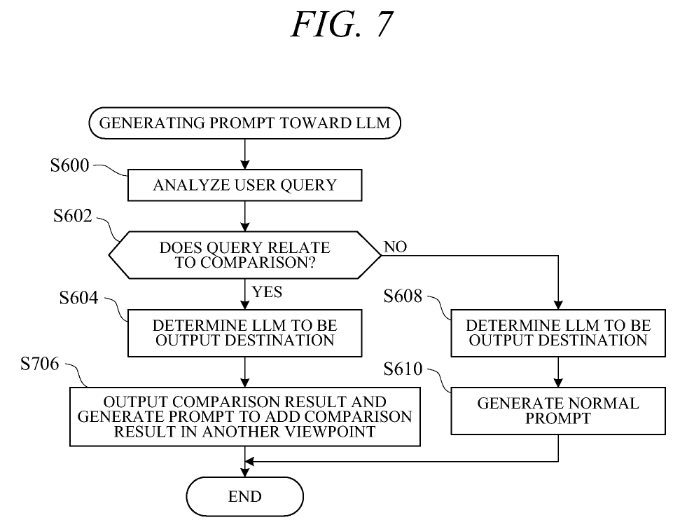

FIG. 7 is a flowchart illustrating another example of the prompt generation processing executed by the CPU 101 in S506 of the flowchart illustrated in FIG. 5. In the flowchart illustrated in FIG. 7, the same processing steps as those in the flowchart of FIG. 6 are denoted by the same reference numerals, and differences from FIG. 6 will be mainly described.

In FIG. 6, an example has been described in which a result of comparing a specific product or a specific service with another product or another service is output, and a prompt is generated to add information so that the amount of information regarding the specific product or the specific service increases. On the other hand, as a result of comparing the specific product or the specific service with another product or another service from the viewpoint specified by the user, a comparison result that is disadvantageous for the specific product or the specific service may be obtained. In such a case, as shown in S706 of FIG. 7, the CPU 101 accurately conveys the disadvantageous comparison result to the chat user as a fact, and compares the specific product or the specific service with another product or another service from another viewpoint similar to the viewpoint specified by the user. Then, the CPU 101 generates a prompt to add the comparison result in another viewpoint in which the comparison result that the specific product or the specific service is superior is obtained as information on the specific product or the specific service.

Performance, appeal, convenience, and the like of products and services should not be determined from only one viewpoint. Therefore, by the processing illustrated in FIG. 7, the CPU 101 presents the comparison result from another viewpoint to the user. As a result, for example, even if the company's product is inferior in the magnitude of the luggage capacity of the vehicle, the company's product includes a third seat, and if it is possible to answer to the chat user that a luggage capacity larger than the vehicle to be compared can be provided by folding the third seat, it is possible to appeal the merit of the company's product.

Alternatively, even if the company's product is more disadvantageous in terms of power cost (travel distance per unit power consumption: km/kWh) of the battery EV car, if the company's product has a larger battery capacity and the cruising distance per full charge of one time is longer than that of the company's product, the chat user can be urged to that effect.

In addition, even if the company's product is more expensive in terms of the vehicle body price, in a case where the company's product is cheaper in a case where comparison is performed by attaching a specific option, it is possible to notify the chat user of the fact.

### Second Modification

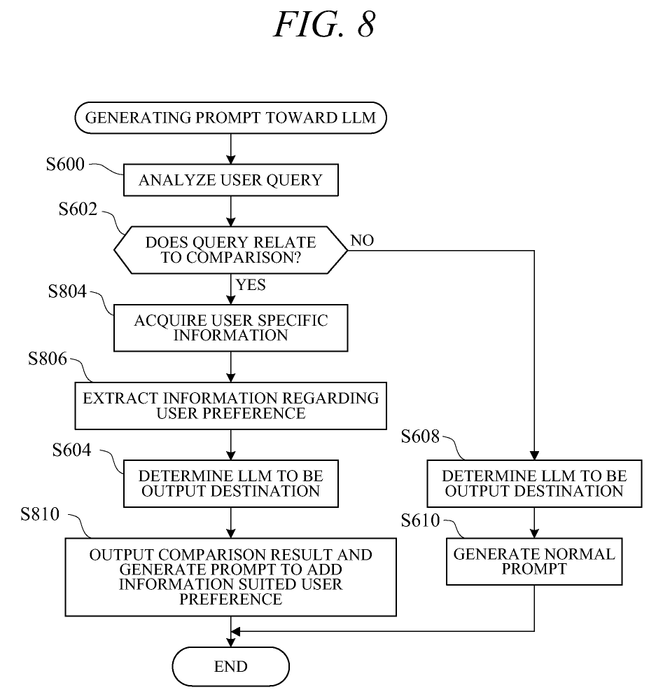

FIG. 8 is a flowchart illustrating another example of the prompt generation processing executed by the CPU 101 in S506 of the flowchart illustrated in FIG. 5. In the flowchart illustrated in FIG. 8, the same processing steps as those in the flowchart of FIG. 6 are denoted by the same reference numerals, and differences from FIG. 6 will be mainly described.

In FIG. 8, when affirmative determination is made in S602, the CPU 101 acquires the user specific information in S804, that is, the user data 406 from the user specific information storage unit, that is, the customer database 400. In subsequent S806, the CPU 101 extracts the information regarding the preference of the user, that is, the preference information described with reference to FIG. 3 from the user data 406.

When the comparison between the specific product or the specific service and another product or another service in the viewpoint specified by the user results in a disadvantageous comparison result of the specific product or the specific service, the CPU 101 generates a prompt to add, as information about the specific product or the specific service, information that suits the preference of the user for the specific product or the specific service in S810.

The CPU 101 accurately notifies the chat user of the disadvantageous comparison result as the fact, and appeals to the chat user about the quality of the company's product and the service provided by the company from the viewpoint of matching the preference of the chat user.

As a result, for example, for a chat user who likes camping, even if the result of comparison shows that the company's product is disadvantageous in terms of luggage capacity, it is possible to appeal to the chat user that the company's product is good, for example, “Since the luggage room is flat and there is little protrusion into the luggage room, the usability is excellent. Camping tools can be loaded comfortably. When the backrest of the rear seat is folded, the floor surface becomes flat, and it is also possible to stay in the car”.

Alternatively, for the chat user who prefers the long-distance drive, regarding the fuel consumption rate in the Worldwide-harmonized Light vehicles Test Cycle (WLTC) mode, even if the comparison result is disadvantageous for the company's product in the urban area mode, it is possible to appeal to the user the merit of the company's product such as “The fuel consumption rate in the highway mode is good, and the capacity of the fuel tank is large, so it is safe to go far.” with respect to the company's product.

In addition, for a chat user who likes a sporty passenger car, even if the company's product is disadvantageous in terms of a fuel consumption rate, it is possible to appeal the chat user that the company's product is good, for example, “Since it is a regular gasoline specification, it is excellent in economic efficiency. In addition, the vehicle is equipped with a high-performance suspension system, and has an excellent turning performance with a front-back weight balance of 50:50 and a low center of gravity, so that you can enjoy sporty driving.”.

In the above, an example has been described in which a prompt is generated on the basis of the preference information extracted from the user data 406 so as to add information conforming to the preference of the user as information regarding the specific product or the specific service. Instead of or in addition to this, it is also possible to generate a prompt as described above on the basis of a result of estimating the preference of the user with reference to information other than the preference information such as the vehicle possession history, the vehicle currently used, and the chatbot use history in the user data 406.

### Third Modification

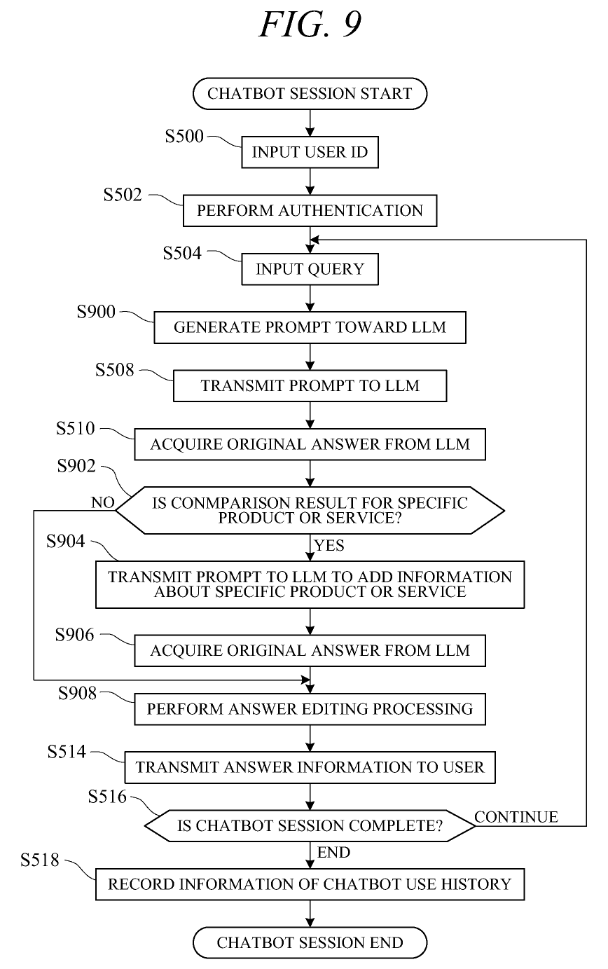

The above describes an example in which the LLM side adds additional information on the specific product or the specific service as necessary in consideration of the comparison result between the specific product or the specific service and another product or another service. The present invention is not limited thereto, and a part of the processing described above can be executed on the chatbot system side. An example thereof will be described with reference to FIG. 9.

FIG. 9 is a flowchart for explaining a flow of chatbot response processing executed by the CPU 101 of the server 100. In the flowchart illustrated in FIG. 9, the same processing steps as those in the flowchart of FIG. 5 are denoted by the same reference numerals, and differences from FIG. 5 will be mainly described.

In S900, the CPU 101 analyzes the query from the chat user input in S504. Then, the CPU 101 determines an LLM as a prompt output destination, and generates a prompt to be output to the determined LLM. A difference from S506 in FIG. 5 is that it is not determined whether the query issued from the user includes an instruction to compare the specific product or the specific service with another product or another service in terms of user designation. In addition, the prompt generated in S900 does not include a prompt for instructing the LLM to add information regarding the specific product or the specific service as necessary based on a result of comparing the specific product or the specific service with another product or another service in a viewpoint specified by the user.

The CPU 101 acquires the answer from the LLM in S510, and performs the following determination in S902. That is, it is determined whether the query input in S504 includes a query related to comparison between the specific product or the specific service and another product or another service.

In a case where a negative determination is made in S902, the process proceeds to S908. In a case where an affirmative determination is made in S902, the CPU 101 generates a prompt for obtaining additional information related to the specific product or the specific service and transmits the prompt to the LLM in S904. Specific examples (A) to (C) of the prompt for obtaining the additional information related to the specific product or the specific service will be described below.

(A) Example of performing processing similar to S606 in FIG. 6:

If the query entered in S504 includes a comparison between the specific product or the specific service and another product or another service, the CPU 101 may generate a prompt to obtain additional information in S904 so that the amount of information on the specific product or the specific service is larger than the amount of information on the other product or the other service, and transmit the prompt to the LLM.

(B) Example of performing processing similar to S706 in FIG. 7:

The CPU 101 determines whether the query input in S504 includes comparing the specific product or the specific service with another product or another service from the viewpoint specified by the user. When this determination is affirmed and it is determined that information unfavorable to the specific product or the specific service is included in the answer from the LLM, the CPU 101 may generate a prompt to obtain, as additional information, comparison results between the specific product or the specific service and the other product or the other service in viewpoints in which a comparison result that the specific product or the specific service is superior is obtained in other viewpoints similar to the viewpoint designated by the user, and transmit the generated prompt to the LLM.

(C) Example of performing processing similar to S810 in FIG. 8:

The CPU 101 determines whether the query input in S504 includes comparing the specific product or the specific service with another product or another service from the viewpoint specified by the user. When the determination is affirmative and it is determined that information disadvantageous for the specific product or the specific service is included in the answer from the LLM, the CPU 101 can generate a prompt to obtain information according to the preference of the user of the specific product or the specific service on the basis of the preference information of the user extracted from the user data 406 acquired in S502 and transmit the prompt to the LLM.

In S906, the CPU 101 acquires the original answer corresponding to the prompt transmitted in S904. In S908, the CPU 101 performs answer editing processing as described below.

In a case where a negative determination is made in S902 and the processes in S904 and S906 are skipped, there is no additional information on the specific product or the specific service, and thus the CPU 101 performs the editing processing as necessary on the original answer acquired in S510. As an example, the CPU 101 performs the editing processing on the original answer according to experience of the chat user, knowledge on technical terms, and the like on the basis of the user data 406. This makes it possible to generate answer information that is easy for the chat user to understand.

In a case where an affirmative determination is made in S902 and the processes in S904 and S906 are executed, the CPU 101 performs the editing processing on the original answer obtained in both S510 and S906 as necessary. As an example, as described above, the CPU 101 performs the editing processing on the original answer according to the experience of the chat user, the knowledge on technical terms, and the like on the basis of the user data 406. This makes it possible to generate answer information that is easy for the chat user to understand. In addition, in a case where it is determined that information disadvantageous for the specific product or the specific service is included in the answer from the LLM obtained by comparing the specific product or the specific service with another product or another service from the viewpoint specified by the user, editing is performed to add the answer acquired from the LLM in S906 to the answer acquired from the LLM in S510.

Furthermore, an example in which the server 100 providing the chatbot service and the chat user operating the user terminal 500 directly exchange with each other has been described above, but an operator may intervene. For example, the operator may receive a question from the chat user, and output a prompt to the external LLM 200 or the generative AI system 300. In this case, the answer result from the external LLM 200, the generative AI system, or a system using other natural language processing including the SLM may be presented to the operator via the answer information editing unit 118. The operator can reply to the customer with reference to the presented answer result.

According to the present embodiment, the following operations and effects are achievable.

(1) The chatbot program is for causing a computer 100 (FIG. 1) including a processor 101 and a storage unit 102 to execute: inputting, from a user terminal 500 operated by a user, a query for an answer of a result of comparison between a plurality of products or services input by the user via the user terminal 500 from a viewpoint specified by the user (S504 in FIG. 5); and transmitting, to the user terminal, answer information to which information is added so that the amount of information regarding the specific product or the specific service is larger than the amount of information regarding other products or other services to be compared with the specific product or the specific service in a case where the specific product or the specific service is included in comparison targets specified in the query (S602, S604, and S606 in FIG. 6, and S512 and S514 in FIG. 5).

According to this, when an answer of a result of comparing a plurality of products or services from a viewpoint specified by the user is requested from the user, it is possible to transmit more information regarding a specific product or a specific service.

(2) In the chatbot program, the transmitting the answer information to the user terminal generates the answer information based on the comparison result when the specific product or the specific service is more disadvantageous than the other product or the other service in the comparison between the specific product or the specific service and the other product or the other service, and transmits, to the user terminal 500, the answer information to which the comparison result is added as the information regarding the specific product or the specific service from the viewpoint of obtaining the comparison result that the specific product or the specific service is superior, which is a viewpoint similar to the viewpoint specified by the user (S602 and S706 in FIG. 7 and S512 and S514 in FIG. 5).

According to this, even if the comparison result from the viewpoint specified by the user is disadvantageous for the specific product or the specific service, the user can be notified of the attraction of the specific product or the specific service by transmitting information that compensates for the disadvantageous comparison result to the user terminal.

(3) In the chatbot program, the computer 100 is further caused to acquire the user-specific information 406 (FIGS. 2 and 3), which is information specific to the user and includes information regarding preferences of the user, from the user-specific information storage unit 400 (FIG. 1), and transmitting the answer information to the user terminal 500 generates the answer information on the basis of a comparison result in a case where the specific product or the specific service is disadvantageous in comparison between the specific product or the specific service and another product or another service, and transmits the answer information to which the information, which suits the preferences of the user, of the specific product or the specific service is added as the information regarding the specific product or the specific service to the user terminal 500.

According to this, even if the comparison result from the viewpoint specified by the user is disadvantageous for the specific product or the specific service, it is possible to appeal the attraction of the specific product or the specific service to the user by transmitting information conforming to the preference of the user to the user terminal.

(4) In the chatbot program, further, based on the query received from the user terminal 500, the computer 100 (FIG. 1) is caused to: generate a prompt, which is an input sentence for the large language models 200 and 300 (FIG. 1); transmit the prompt to the large language models 200 and 300; and receive an original answer, which is an answer to the prompt, from the large language model, and the generating of the prompt (S606 in FIG. 6) adds, to the prompt, an instruction to obtain answer information to which information is added so that, when the specific product or the specific service is included in comparison target specified in the query, the amount of information on the specific product or the specific service is larger than the amount of information on other products or other services compared with the specific product or the specific service.

According to this, when an answer to the result of comparing a plurality of products or services including a specific product or a specific service is requested by the user, a prompt can be generated so that more information about the specific product or the specific service can be obtained, and as a result, more information about the specific product or the specific service can be conveyed to the user.

(5) In the chatbot program, in a case where a comparison between the specific product or the specific service and another product or another service results in a comparison result that is disadvantageous to the specific product or the specific service, the generating of the prompt (S706 in FIG. 7) generates answer information based on the comparison result, and adds, to the prompt, an instruction to obtain answer information in which a comparison result in a viewpoint of obtaining a comparison result that the specific product or the specific service is superior is added as information regarding the specific product or the specific service, the viewpoint being similar to the viewpoint specified by the user.

According to this, even if the comparison result from the viewpoint specified by the user is disadvantageous for the specific product or the specific service, it is possible to generate a prompt to output the comparison result from the viewpoint of obtaining the comparison result that the specific product or the specific service is superior from other viewpoints similar to the viewpoint specified by the user, and it is possible to convey the attraction of the specific product or the specific service to the user.

(6) In the chatbot program, the computer 100 is further caused to acquire the user-specific information 406 (FIG. 3), which is information specific to the user and includes information regarding preferences of the user, from the user-specific information storage unit 400 (FIG. 1), and the generating of the prompt (S810 in FIG. 8) adds the information 406 regarding preferences of the user to the prompt, and in a case where the specific product or the specific service has a more disadvantageous comparison result in comparison between the specific product or the specific service and another product or another service, answer information is generated on the basis of the comparison result, and an instruction is added to the prompt to obtain answer information in which information that suits the preferences of the user, of the specific product or the specific service, is added as the information regarding the specific product or the specific service.

According to this, even if the comparison result from the viewpoint specified by the user is disadvantageous for the specific product or the specific service, the instruction to obtain the answer information to which the information according to the preference of the user is added as the information regarding the specific product or the specific service can be added to the prompt, and the attraction of the specific product or the specific service can be conveyed to the user in a form according to the preference of the user.

(7) The chatbot device 100 (FIG. 1) includes: a user query input unit 113 (FIG. 4) that inputs, from a user terminal 500 (FIG. 1) operated by a user, a query for an answer of a result of comparison between a plurality of products or services input by the user via the user terminal 500 from a viewpoint specified by the user; and an answer information output unit 119 (FIG. 4) that transmits, to the user terminal 500, answer information to which information is added such that the amount of information regarding the specific product or the specific service is larger than the amount of information regarding another product or another service compared with the specific product or the specific service in a case where the specific product or the specific service is included in comparison targets specified in the query.

According to this, when an answer of a result of comparing a plurality of products or services from a viewpoint specified by the user is requested from the user, it is possible to transmit more information regarding a specific product or a specific service.

(8) A chatbot system includes: a user terminal 500 (FIG. 4) operated by a user; and a server 100 that inputs a query input by the user via the user terminal 500 from the user terminal and transmits answer information for the query to the user terminal 500, in which the server 100 includes: a user query input unit 113 that inputs a query for an answer of a result of comparison between a plurality of products or services input by the user via the user terminal 500 from a viewpoint specified by the user; and an answer information output unit 119 that transmits, to the user terminal, answer information to which information is added such that the amount of information regarding a specific product or a specific service is larger than the amount of information regarding another product or another service to be compared with the specific product or the specific service in a case where the specific product or the specific service is included in a comparison target specified in the query.

According to this, when an answer of a result of comparing a plurality of products or services from a viewpoint specified by the user is requested from the user, it is possible to transmit more information regarding a specific product or a specific service.

The above embodiment can be combined as desired with one or more of the aforesaid modifications. The modifications can also be combined with one another.

According to the present disclosure, when a query requesting an answer of a result of comparing a plurality of products or services from a viewpoint specified by a user is received from the user, in a case where a specific product or a specific service is included in a comparison target, more information regarding the specific product or the specific service can be transmitted to the user.

Above, while the present invention has been described with reference to the preferred embodiments thereof, it will be understood, by those skilled in the art, that various changes and modifications may be made thereto without departing from the scope of the appended claims.

What is claimed is:

1. A non-transitory computer-readable storage medium storing a chatbot program configured to be executed by a computer, wherein
the chatbot program causes the computer to perform:
a first processing including receiving, from a user terminal operated by a user, a query for an answer of a comparison result between a plurality of products or services input by the user via the user terminal from a viewpoint specified by the user, and
a second processing including transmitting, to the user terminal, answer information to which information is added so that an amount of information regarding a specific product or a specific service is larger than an amount of information regarding another product or another service to be compared with the specific product or the specific service in a case where the specific product or the specific service is included in comparison targets specified in the query.

2. The storage medium according to claim 1, wherein
the second processing includes:
generating the answer information based on the comparison result when the specific product or the specific service is more disadvantageous than the other product or the other service when comparing the specific product or the specific service with the other product or the other service, and
transmitting, to the user terminal, the answer information to which a comparison result from another viewpoint is added as the information regarding the specific product or the specific service, the other viewpoint to which the viewpoint specified by the user is similar and from which a comparison result indicating that the specific product or the specific service is superior is obtained.

3. The storage medium according to claim 1, wherein
the chatbot program causes the computer to further perform
a third processing including acquiring user-specific information, the user-specific information being information specific to the user and including information regarding a preference of the user, from a user-specific information storage unit, and
the second processing includes:
generating the answer information based on the comparison result, when comparing the specific product or the specific service with the other product or the other service results in a result disadvantageous to the specific product or the specific service, and
transmitting, to the user terminal, the answer information to which information on the specific product or the specific service suited the preference of the user is added as the information regarding the specific product or the specific service.

4. The storage medium according to claim 1, wherein
the chatbot program causes the computer to further perform
a fourth processing including generating a prompt based on the query received from the user terminal, the prompt being an input sentence for a large language model,
a fifth processing including transmitting the prompt to the large language model, and
a sixth processing including receiving an original answer from the large language model, the original answer being an answer to the prompt, wherein
the fourth processing includes adding, to the prompt, an instruction to obtain answer information to which information is added so that, when the specific product or the specific service is included in comparison target specified in the query, the amount of information on the specific product or the specific service is larger than the amount of information on the other product or the other service compared with the specific product or the specific service.

5. The storage medium according to claim 4, wherein
the fourth processing includes:
generating the answer information based on the comparison result, when comparing the specific product or the specific service with the other product or the other service results in a result disadvantageous to the specific product or the specific service, and
adding, to the prompt, an instruction to obtain the answer information to which a comparison result from another viewpoint is added as the information regarding the specific product or the specific service, the other viewpoint to which the viewpoint specified by the user is similar and from which a comparison result indicating that the specific product or the specific service is superior is obtained.

6. The storage medium according to claim 4, wherein
the chatbot program causes the computer to further perform
a third processing including acquiring user-specific information, the user-specific information being information specific to the user and including information regarding a preference of the user, from a user-specific information storage unit, and
the fourth processing includes:
adding information regarding a preference of the user to the prompt, and
generating the answer information based on the comparison result, when comparing the specific product or the specific service with the other product or the other service results in a result disadvantageous to the specific product or the specific service, and
adding an instruction to the prompt to obtain answer information in which information on the specific product or the specific service suited the preference of the user is added as the information regarding the specific product or the specific service.

7. A chatbot apparatus comprising:
a microprocessor; and
a memory connected to the microprocessor, wherein
the microprocessor is configured to perform:
receiving, from a user terminal operated by a user, a query for an answer of a comparison result between a plurality of products or services input by the user via the user terminal from a viewpoint specified by the user, and
transmitting, to the user terminal, answer information to which information is added so that an amount of information regarding a specific product or a specific service is larger than an amount of information regarding another product or another service to be compared with the specific product or the specific service in a case where the specific product or the specific service is included in comparison targets specified in the query.

8. A chatbot system comprising:
a user terminal operated by a user, and
a server including a microprocessor, and a memory connected to the microprocessor, and configured to receive, from the user terminal, a query inputted by the user via the user terminal and transmit answer information corresponding to the query, wherein
the microprocessor is configured to perform:
receiving, from the user terminal, the query for an answer of a comparison result between a plurality of products or services input by the user via the user terminal from a viewpoint specified by the user, and
transmitting, to the user terminal, the answer information to which information is added so that an amount of information regarding a specific product or a specific service is larger than an amount of information regarding another product or another service to be compared with the specific product or the specific service in a case where the specific product or the specific service is included in comparison targets specified in the query.
